(19) United States
(12) Patent Application Publication
(10) Pub. No.: US 2026/0009916 A1
(43) Pub. Date: Jan. 8, 2026

(54) FOURIER-SERIES IMAGING CONDITION

(71) Applicant: Schlumberger Technology Corporation, Sugar Land, TX (US)

(72) Inventors: Zongcai Feng, Houston, TX (US); Xin Cheng, Houston, TX (US); Denes Vigh, Houston, TX (US); Mohamed Hegazy, Sugar Land, TX (US)

(21) Appl. No.: 19/246,836

(22) Filed: Jun. 24, 2025

Related U.S. Application Data
(60) Provisional application No. 63/666,798, filed on Jul. 2, 2024.

(51) Int. Cl. G01V 1/28; G01V 1/30

(52) U.S. Cl. CPC G01V 1/282; G01V 1/307

(57) ABSTRACT

A method for performing seismic imaging of a subsurface formation includes receiving input data. The method also includes generating a simulated source-side wavefield and a simulated receiver-side wavefield based upon the input data. The method also includes producing an angle gather based upon the simulated source-side wavefield and the simulated receiver-side wavefield. The method also includes utilizing the angle gather in a virtual source term in Born modeling to improve an image quality of the angle gather.

### CROSS-REFERENCE TO RELATED APPLICATIONS

This application claims priority to U.S. Provisional Patent Application No. 63/666,798, filed on Jul. 2, 2024, which is incorporated by reference.

### BACKGROUND

Reverse time migration (RTM) is tool in seismic imaging, particularly in regions with complex geological structures. RTM has served roles both as a quality control (QC) tool and as a means to generate high-fidelity subsurface images. The imaging process may include two phases: (1) wavefield modeling phase, involving the generation of the source-side pressure wavefield and receiver-side pressure wavefield, and (2) applying the image condition. While the wavefield modeling phase may employ acoustic wave propagation, known as acoustic RTM (ARTM), recent advancements have expanded imaging capabilities with elastic RTM (ERTM), leveraging the wavefield modeling potential of elastic full-waveform inversion (EFWI).

However, the imaging condition phase remains incomplete, primarily addressing certain issues such as reducing the backscattering or wavefield separation in an RTM image, especially when constrained to application of temporal derivative/integration and spatial derivatives. Consequently, the application of ARTM/ERTM is often restricted, resulting in a single image via a basic cross-correlation imaging condition between the source-side pressure wavefield and receiver-side pressure wavefield.

Therefore, what is needed is an improved system and method for enhancing the ARTM/ERTM imaging capabilities (e.g., using a Fourier-series imaging condition).

### SUMMARY

A method for performing seismic imaging of a subsurface formation is disclosed. The method includes receiving input data. The method also includes generating a simulated source-side wavefield and a simulated receiver-side wavefield based upon the input data. The method also includes producing an angle gather based upon the simulated source-side wavefield and the simulated receiver-side wavefield. The method also includes utilizing the angle gather in a virtual source term in Born modeling to improve an image quality of the angle gather.

A computing system is also disclosed. The computing system includes one or more processors and a memory system. The memory system includes one or more non-transitory computer-readable media storing instructions that, when executed by at least one of the one or more processors, cause the computing system to perform operations. The operations include receiving input data. The input data includes seismic data. The seismic data includes seismic waves travelling through the subsurface formation. The operations also include generating a simulated source-side wavefield, a simulated receiver-side wavefield, and a P-wave velocity model based upon the input data. The simulated source-side wavefield is a forward simulation of the seismic waves. The simulated receiver-side wavefield is a backward simulation of the seismic waves. The P-wave velocity model is generated using seismic tomography and full waveform inversion (FWI). The operations also include producing an angle gather based upon the simulated source-side wavefield and the simulated receiver-side wavefield. The angle gather includes a plurality of subsurface images having different reflection angles. The angle gather is produced by constructing Fourier-series terms in a Fourier-series imaging condition. The operations also include utilizing the angle gather in a virtual source term in Born modeling to improve an image quality of the angle gather. The angle gather is utilized according to an adjoint of the Fourier-series imaging condition for a least-square reverse time migration, which iteratively improves the image quality of the angle gather.

A non-transitory computer-readable medium is also disclosed. The medium stores instructions that, when executed by one or more processors of a computing system, cause the computing system to perform operations. The operations include receiving input data. The input data includes seismic data. The seismic data includes seismic waves travelling through the subsurface formation. The operations also include generating a simulated source-side wavefield, a simulated receiver-side wavefield, and a P-wave velocity model based upon the input data. The simulated source-side wavefield is a forward simulation of the seismic waves. The simulated receiver-side wavefield is a backward simulation of the seismic waves. The P-wave velocity model is generated using seismic tomography and full waveform inversion (FWI). The operations also include producing an angle gather based upon the simulated source-side wavefield and the simulated receiver-side wavefield. The angle gather includes a plurality of subsurface images having different reflection angles. The angle gather is produced by (1) constructing Fourier-series terms based upon the simulated source-side wavefield, the simulated receiver-side wavefield, and the P-wave velocity model. The Fourier-series terms are constructed in a Fourier-series imaging condition by applying different orders of time integrations and spatial gradients to the simulated source-side wavefield and the simulated receiver-side wavefield before they are combined in the Fourier-series imaging condition. The Fourier-series imaging condition is used to construct the subsurface images. The Fourier-series imaging condition is determined based upon the simulated source-side wavefield and the simulated receiver-side wavefield. The angle gather is also produced by (2) determining Fourier-series coefficients based upon a scattering pattern. The scattering pattern is determined based upon weight stacking of the subsurface images with different reflection angles. The angle gather is also produced by (3) weight stacking the Fourier-series terms using the Fourier-series coefficients to produce the angle gather. Rotation and/or reciprocity are applied to the Fourier-series imaging condition. In response to rotation being applied to the Fourier-series imaging condition, the rotation effectively transforms one of the subsurface images having a zero reflection angle into the subsurface images with the different reflection angles by rotating the spatial gradients in the Fourier-series imaging condition. In response to reciprocity being applied to the Fourier-series imaging condition and a series order of the Fourier-series terms being set to 2, the Fourier-series imaging condition is considered to be an elastic imaging condition for generating a reverse time migration angle gather. In response to reciprocity being applied to the Fourier-series imaging condition and the series order of the Fourier-series terms being set to be greater than 2, the Fourier-series imaging condition generates the reverse time migration angle gather with an angle resolution that is greater than an angle resolution achieved by the elastic imaging condition. The operations also include utilizing the angle gather in a virtual source term in Born modeling to improve an image quality of the angle gather. The angle gather is utilized according to an adjoint of the Fourier-series imaging condition for a least-square reverse time migration, which iteratively improves the image quality of the angle gather. The virtual source term utilizes the angle gather as a source in the Born modeling. The Born modeling linearizes a seismic wave equation that uses the virtual source term to re-radiate the simulated source-side wavefield. The operations also include incorporating a higher-order virtual source term in the Born modeling with the series order of greater than 2 in an elastic full waveform inversion to iteratively improve an angle resolution of the angle gather. The operations also include displaying the angle gather with the improved image quality and the improved angle resolution.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example computing system, according to an embodiment.

FIG. 2 illustrates a survey operation being performed by a survey tool to measure properties of the subterranean formation, according to an embodiment.

FIG. 3 illustrates a drilling operation being performed by drilling tools suspended by a rig and advanced into subterranean formations to form a wellbore, according to an embodiment.

FIG. 4 illustrates a wireline operation being performed by a wireline tool suspended by the rig and into the wellbore of FIG. 3.

FIG. 5 illustrates a production operation being performed by a production tool deployed from a production unit or Christmas tree and into the completed wellbore for drawing fluid from the downhole reservoirs into the surface facilities, according to an embodiment.

FIG. 6 illustrates a schematic view, partially in cross section of an oilfield having data acquisition tools positioned at various locations along an oilfield for collecting data of a subterranean formation, according to an embodiment.

FIG. 7 illustrates an oilfield for performing production operations in accordance with implementations of various technologies and techniques described herein.

FIGS. 8A-8F illustrate scattering patterns, according to an embodiment.

FIG. 9A illustrates the basic RTM image produced from a single shot, while FIGS. 9B-9D illustrate an RTM angle gather of three chosen angles, according to an embodiment.

FIG. 10 illustrates a workflow for Fourier-series imaging condition for RTM angle gather, according to an embodiment.

FIG. 11 illustrates a workflow for LSRTM angle gather using Fourier-series imaging condition, according to an embodiment.

FIGS. 12A-12C illustrate a PP scattering pattern of elastic parameterization, according to an embodiment.

FIG. 13 illustrates elastic parameterization using Fourier-series imaging condition and applying it in EFWI, according to an embodiment

FIG. 14 illustrates a flowchart of a method for performing seismic imaging of a subterranean formation, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the invention herein is for the purpose of describing particular embodiments and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, e.g., all of the components of a wavefield, all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset.

### Computing Systems

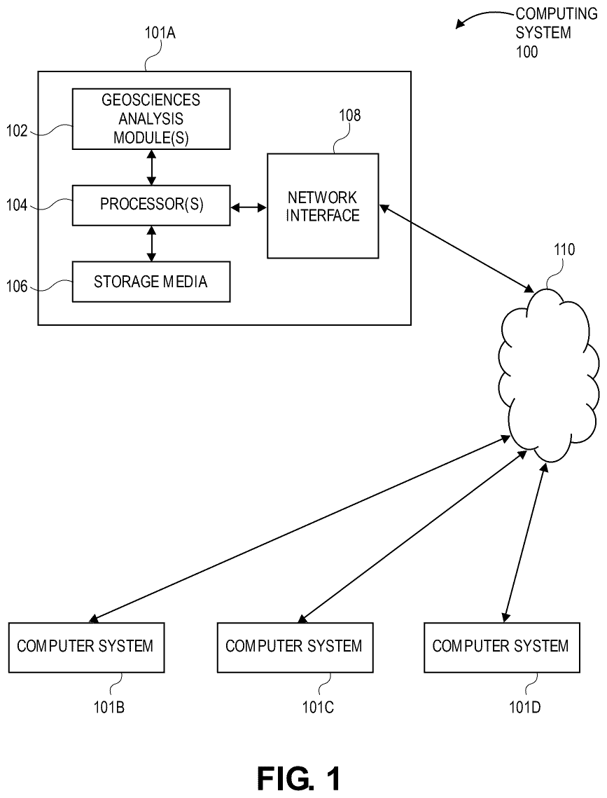

FIG. 1 illustrates an example computing system 100 in accordance with some embodiments. The computing system 100 can be an individual computer system 101A or an arrangement of distributed computer systems. The computer system 101A includes one or more geosciences analysis modules 102 that are configured to perform various tasks according to some embodiments, such as one or more methods disclosed herein. To perform these various tasks, geosciences analysis module 102 executes independently, or in coordination with, one or more processors 104, which is (or are) connected to one or more storage media 106. The processor(s) 104 is (or are) also connected to a network interface 108 to allow the computer system 101A to communicate over a data network 110 with one or more additional computer systems and/or computing systems, such as 101B, 101C, and/or 101D (note that computer systems 101B, 101C and/or 101D may or may not share the same architecture as computer system 101A, and may be located in different physical locations, e.g., computer systems 101A and 101B may be on a ship underway on the ocean, while in communication with one or more computer systems such as 101C and/or 101D that are located in one or more data centers on shore, other ships, and/or located in varying countries on different continents). Note that data network 110 may be a private network, it may use portions of public networks, it may include remote storage and/or applications processing capabilities (e.g., cloud computing).

A processor can include a microprocessor, microcontroller, processor module or subsystem, programmable integrated circuit, programmable gate array, or another control or computing device.

The storage media 106 can be implemented as one or more computer-readable or machine-readable storage media. Note that while in the example embodiment of FIG. 1 storage media 106 is depicted as within computer system 101A, in some embodiments, storage media 106 may be distributed within and/or across multiple internal and/or external enclosures of computing system 101A and/or additional computing systems. Storage media 106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. Note that the instructions discussed above can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computer system 101A is one example of a computing system, and that computer system 101A may have more or fewer components than shown, may combine additional components not depicted in the example embodiment of FIG. 1, and/or computer system 101A may have a different configuration or arrangement of the components depicted in FIG. 1. The various components shown in FIG. 1 may be implemented in hardware, software, or a combination of both, hardware and software, including one or more signal processing and/or application specific integrated circuits.

It should also be appreciated that while no user input/output peripherals are illustrated with respect to computer systems 101A, 101B, 101C, and 101D, many embodiments of computing system 100 include computer systems with keyboards, mice, touch screens, displays, etc. Some computer systems in use in computing system 100 may be desktop workstations, laptops, tablet computers, smartphones, server computers, etc.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of protection.

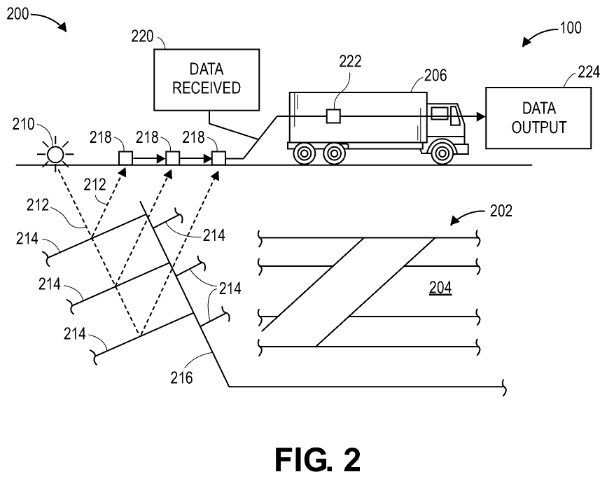

FIGS. 2-5 illustrate simplified, schematic views of an oilfield 200 having a subterranean formation 202 containing a reservoir 204 therein in accordance with implementations of various technologies and techniques described herein. More particularly, FIG. 2 illustrates a survey operation being performed by a survey tool, such as a seismic truck 206.1, to measure properties of the subterranean formation. The survey operation is a seismic survey operation for producing sound vibrations. In FIG. 2, one such sound vibration, e.g., sound vibration 212 generated by a source 210, reflects off horizons 214 in an earth formation 216. A set of sound vibrations is received by sensors, such as geophone-receivers 218, situated on the earth's surface. The data received 220 is provided as input data to a computer 222.1 of a seismic truck 206.1, and responsive to the input data, the computer 222.1 generates seismic data output 224. This seismic data output may be stored, transmitted or further processed as desired, for example, by data reduction.

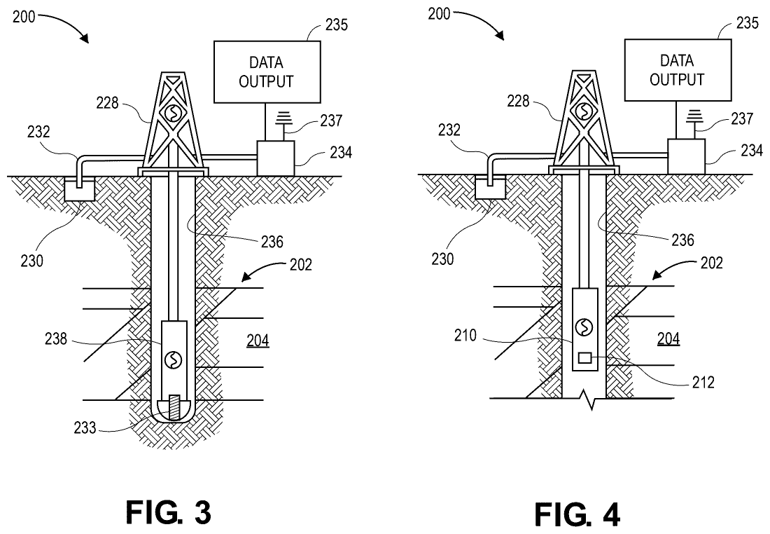

FIG. 3 illustrates a drilling operation being performed by drilling tools 206.2 suspended by a rig 228 and advanced into subterranean formations 202 to form a wellbore 236. A mud pit 230 is used to draw drilling mud into the drilling tools via a flow line 232 for circulating drilling mud down through the drilling tools, then up the wellbore 236 and back to the surface. The drilling mud is typically filtered and returned to the mud pit. A circulating system may be used for storing, controlling, or filtering the flowing drilling mud. The drilling tools are advanced into the subterranean formations 202 to reach the reservoir 204. Each well may target one or more reservoirs. The drilling tools are adapted for measuring downhole properties using logging while drilling tools. The logging while drilling tools may also be adapted for taking core sample 233 as shown.

Computer facilities may be positioned at various locations about the oilfield 200 (e.g., the surface unit 234) and/or at remote locations. The surface unit 234 may be used to communicate with the drilling tools and/or offsite operations, as well as with other surface or downhole sensors. The surface unit 234 is capable of communicating with the drilling tools to send commands to the drilling tools, and to receive data therefrom. The surface unit 234 may also collect data generated during the drilling operation and produce data output 235, which may then be stored or transmitted.

Sensors(S), such as gauges, may be positioned about the oilfield 200 to collect data relating to various oilfield operations as described previously. As shown, the sensor(S) is positioned in one or more locations in the drilling tools and/or at the rig 228 to measure drilling parameters, such as weight on bit, torque on bit, pressures, temperatures, flow rates, compositions, rotary speed, and/or other parameters of the field operation. The sensors(S) may also be positioned in one or more locations in the circulating system.

The drilling tools 206.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with the surface unit 234. The bottom hole assembly further includes drill collars for performing various other measurement functions.

The bottom hole assembly may include a communication subassembly that communicates with the surface unit 234. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Typically, the wellbore is drilled according to a drilling plan that is established prior to drilling. The drilling plan typically sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected

The data gathered by sensors(S) may be collected by the surface unit 234 and/or other data collection sources for analysis or other processing. The data collected by sensors(S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

The surface unit 234 may include a transceiver 237 to allow communications between the surface unit 234 and various portions of the oilfield 200 or other locations. The surface unit 234 may also be provided with or functionally connected to one or more controllers (not shown) for actuating mechanisms at the oilfield 200. The surface unit 234 may then send command signals to the oilfield 200 in response to data received. The surface unit 234 may receive commands via a transceiver 237 or may itself execute commands to the controller. A processor may be provided to analyze the data (locally or remotely), make the decisions and/or actuate the controller. In this manner, the oilfield 200 may be selectively adjusted based on the data collected. This technique may be used to optimize (or improve) portions of the field operation, such as controlling drilling, weight on bit, pump rates, or other parameters. These adjustments may be made automatically based on computer protocol, and/or manually by an operator. In some cases, well plans may be adjusted to select optimum (or improved) operating conditions, or to avoid problems.

FIG. 4 illustrates a wireline operation being performed by a wireline tool 206.3 suspended by the rig 228 and into the wellbore 236 of FIG. 3. The wireline tool 206.3 is adapted for deployment into the wellbore 236 for generating well logs, performing downhole tests and/or collecting samples. The wireline tool 206.3 may be used to provide another method and apparatus for performing a seismic survey operation. The wireline tool 206.3 may, for example, have an explosive, radioactive, electrical, or acoustic energy source 244 that sends and/or receives electrical signals to surrounding subterranean formations 202 and fluids therein.

The wireline tool 206.3 may be operatively connected to, for example, geophones 218 and the computer 222.1 of the seismic truck 206.1 of FIG. 2. The wireline tool 206.3 may also provide data to the surface unit 234. The surface unit 234 may collect data generated during the wireline operation and may produce a data output 235 that may be stored or transmitted. The wireline tool w06.3 may be positioned at various depths in the wellbore w36 to provide a survey or other information relating to the subterranean formation w02.

The sensors(S), such as gauges, may be positioned about the oilfield 200 to collect data relating to various field operations as described previously. As shown, the sensor S is positioned in the wireline tool 206.3 to measure downhole parameters which relate to, for example porosity, permeability, fluid composition and/or other parameters of the field operation.

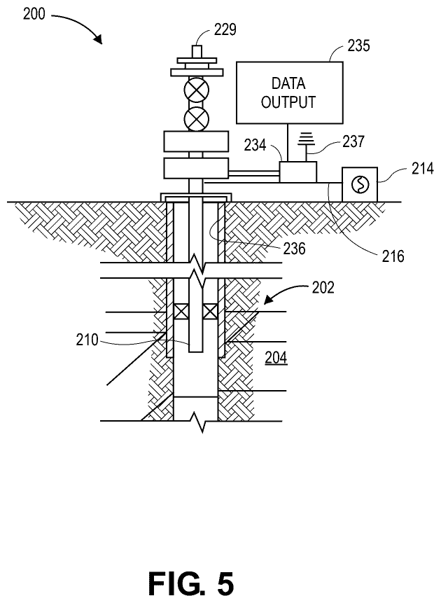

FIG. 5 illustrates a production operation being performed by a production tool 206.4 deployed from a production unit or Christmas tree 229 and into the completed wellbore 236 for drawing fluid from the downhole reservoirs into the surface facilities 242. The fluid flows from the reservoir 204 through perforations in the casing (not shown) and into the production tool 206.4 in the wellbore 236 and to the surface facilities 242 via a gathering network 246.

The sensors(S), such as gauges, may be positioned about the oilfield 200 to collect data relating to various field operations as described previously. As shown, the sensor(S) may be positioned in the production tool 206.4 or associated equipment, such as the Christmas tree 229, the gathering network 246, the surface facility 242, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 3-5 illustrate tools used to measure properties of an oilfield, it will be appreciated that the tools may be used in connection with non-oilfield operations, such as gas fields, mines, aquifers, storage or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors(S) may be located at various positions along the wellbore and/or the monitoring tools to collect and/or monitor the desired data. Other sources of data may also be provided from offsite locations.

The field configurations of FIGS. 2-5 are intended to provide a brief description of an example of a field usable with oilfield application frameworks. Part of, or the entirety, of the oilfield 200 may be on land, water, and/or sea. Also, while a single field measured at a single location is depicted, oilfield applications may be utilized with any combination of one or more oilfields, one or more processing facilities and one or more wellsites.

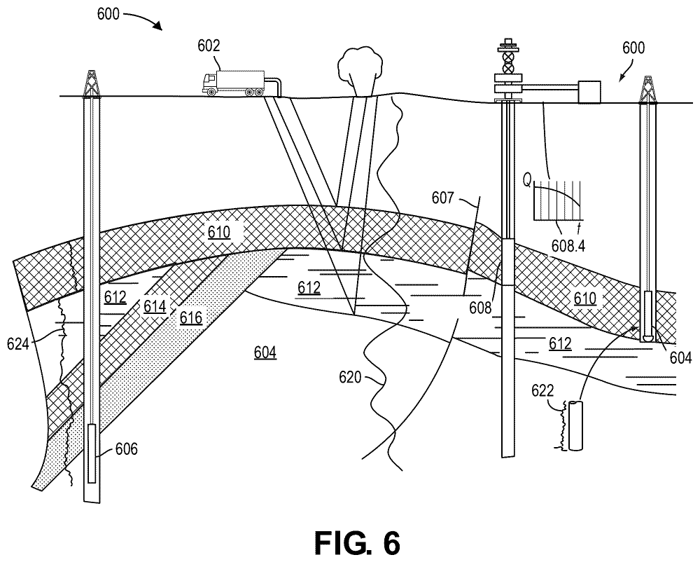

FIG. 6 illustrates a schematic view, partially in cross section of oilfield 600 having data acquisition tools 602.1, 602.2, 602.3 and 602.4 positioned at various locations along an oilfield 600 for collecting data of a subterranean formation 604 in accordance with implementations of various technologies and techniques described herein. Data acquisition tools 602.1-602.4 may be the same as data acquisition tools 206.1-206.4 of FIGS. 2-5, respectively, or others not depicted. As shown, data acquisition tools 602.1-602.4 generate data plots or measurements 608.1-608.4, respectively. These data plots are depicted along the oilfield 600 to demonstrate the data generated by the various operations.

The data plots 608.1-608.3 are examples of static data plots that may be generated by the data acquisition tools 602.1-602.3, respectively; however, it should be understood that the data plots 608.1-608.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

The static data plot 608.1 is a seismic two-way response over a period of time. The static plot 608.2 is core sample data measured from a core sample of the formation 604. The core sample may be used to provide data, such as a graph of the density, porosity, permeability, or some other physical property of the core sample over the length of the core. Tests for density and viscosity may be performed on the fluids in the core at varying pressures and temperatures. The static data plot 608.3 is a logging trace that typically provides a resistivity or other measurement of the formation at various depths.

A production decline curve or graph 608.4 is a dynamic data plot of the fluid flow rate over time. The production decline curve typically provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 604 has a plurality of geological formations 606.1-606.4. As shown, this structure has several formations or layers, including a shale layer 606.1, a carbonate layer 606.2, a shale layer 606.3 and a sand layer 606.4. A fault 607 extends through the shale layer 606.1 and the carbonate layer 606.2. The static data acquisition tools are adapted to take measurements and detect characteristics of the formations.

While a specific subterranean formation with specific geological structures is depicted, it will be appreciated that the oilfield 600 may contain a variety of geological structures and/or formations, sometimes having extreme complexity. In some locations, typically below the water line, fluid may occupy pore spaces of the formations. Each of the measurement devices may be used to measure properties of the formations and/or its geological features. While each acquisition tool is shown as being in specific locations in the oilfield 600, it will be appreciated that one or more types of measurement may be taken at one or more locations across one or more fields or other locations for comparison and/or analysis.

The data collected from various sources, such as the data acquisition tools of FIG. 6, may then be processed and/or evaluated. Typically, seismic data displayed in the static data plot 608.1 from the data acquisition tool 602.1 is used by a geophysicist to determine characteristics of the subterranean formations and features. The core data shown in the static plot 608.2 and/or log data from the well log 608.3 are typically used by a geologist to determine various characteristics of the subterranean formation. The production data from the graph 608.4 is typically used by the reservoir engineer to determine fluid flow reservoir characteristics. The data analyzed by the geologist, geophysicist and the reservoir engineer may be analyzed using modeling techniques.

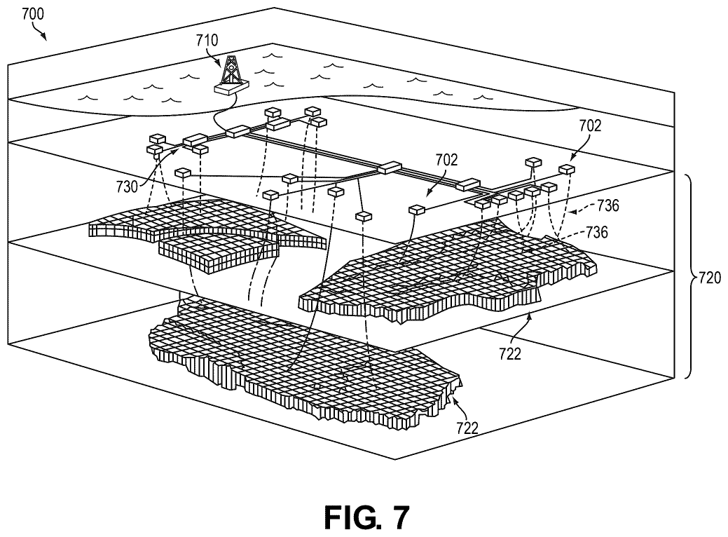

FIG. 7 illustrates an oilfield 700 for performing production operations in accordance with implementations of various technologies and techniques described herein. As shown, the oilfield has a plurality of wellsites 702 operatively connected to a central processing facility 754. The oilfield configuration of FIG. 7 is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 702 has equipment that forms wellbore 736 into the earth. The wellbores extend through subterranean formations 706 including reservoirs 704. These reservoirs 704 contain fluids, such as hydrocarbons. The wellsites draw fluid from the reservoirs and pass them to the processing facilities via surface networks 744. The surface networks 744 have tubing and control mechanisms for controlling the flow of fluids from the wellsite to the processing facility 754.

Attention is now directed to methods, techniques, and workflows for planning, forecasting, and/or optimizing production related systems (e.g., model selections, reservoir maps, wells, etc.) in accordance with some embodiments. Some operations in the processing procedures, methods, techniques, and workflows disclosed herein may be combined and/or the order of some operations may be changed. Those with skill in the art will recognize that in the geosciences and/or other multi-dimensional processing disciplines, various interpretations, sets of assumptions, and/or domain models such as velocity models, may be refined in an iterative fashion; this concept is applicable to the procedures, methods, techniques, and workflows as discussed herein. This iterative refinement can include use of feedback loops executed on an algorithmic basis, such as at a computing device (e.g., computing system 100, FIG. 1), and/or through manual control by a user who may make determinations regarding whether a given step, action, template, or model has become sufficiently accurate.

Fourier-Series Imaging Condition for Angle Gather, Its Application to Elastic Imaging Condition for a Reverse Time Migration Angle Gather, Its Application to Elastic Parameterization for Elastic Full Waveform Inversion, and Surpassing Angle Resolution of Elastic Parameters

To enhance the ARTM/ERTM imaging capabilities, the method described herein uses an imaging condition called Fourier-series imaging condition. Instead of generating a single image, the Fourier-series imaging condition produces an angle gather including a plurality of images of various (e.g., different) reflection angles. The implementation involves constructing Fourier-series terms in imaging condition using different orders of integrations and spatial gradients, and then utilizing Fourier-series coefficients computed from a scattering pattern to weight stack these Fourier-series terms. Additionally, rotation or reciprocity may be applied to simplify the Fourier-series imaging condition. When the Fourier-series order is set to 2 and under reciprocity, it can be considered as an elastic imaging condition for a RTM angle gather. This configuration provides an angle gather with images of three independent angles, which can further be interpreted into more non-independent angles. The angle resolution increases with higher Fourier-series order.

This advanced methodology extends RTM's applicability and enriches the elastic parameterization for EFWI. Elastic parameterization is confined to combinations of physical earth parameters. However, this parameterization still exhibits unbalanced and overlapping sensitivity of reflection data to different parameters and is limited to fixed values of scattering angles. Thus, elastic parameterization may be designed according to desired scattering pattern.

In this context, the imaging condition is delineated as a process of applying temporal derivative/integration and spatial derivatives to the source- and receiver-side wavefields followed by applying the cross-correlation. A straightforward example is the inverse scattering imaging condition (i.e., energy norm imaging condition), which is equivalent to FWI acoustic impedance imaging condition. This imaging condition involves the inner product between the spatial gradients of the source- and receiver-side wavefields, and primarily aims at mitigating low-wavenumber artifacts in RTM images caused by the correlation of source- and receiver-side wavefields propagating in the same direction.

Compared to these approaches, in an embodiment, Fourier-series imaging condition provides greater flexibility in leveraging the imaging condition for generating an RTM angle gather, containing RTM images of various reflection angles, compared to a conventional single RTM image. When adopted in elastic imaging conditioning, it yields an RTM angle gather of three distinct angles, which can be further interpolated into additional angles.

Elastic parameterizations are confined to combinations of physical earth parameters such as (Vₚ, Vₛ, ρ), (Iₚ, Iₛ, ρ),

$$( {I}_{p} , {V}_{p} , \frac{{V}_{p}}{{V}_{s}} ) ,$$

etc. In an embodiment, the Fourier-series imaging condition may be employed to guide the design of elastic parameterization beyond these physical elastic parameters. An EFWI with inversion of these new elastic parameterizations can be converted to a gather by taking their directional derivatives or transformed into (Vₚ, Vₛ, ρ) parameterization for reflectivity computation.

### Introduction of Cross-Correlation Imaging Condition

The conventional imaging condition for RTM utilizes basic cross-correlation:

$${I}_{iso} = \int PRdt , \qquad ( 1 )$$

where Iᵢₛₒ=Iᵢₛₒ(x) represents the RTM image, and P=P(x,t) and R=R(x, t) denote the source- and receiver-side pressure wavefields, respectively.

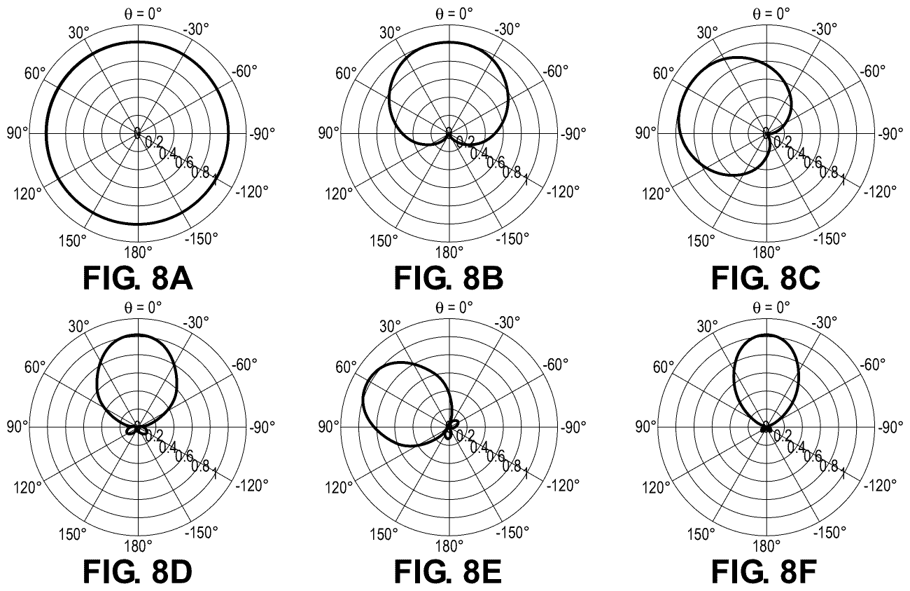

FIGS. 8A-8F illustrate Scattering patterns of (FIG. 8A) Iᵢₛₒ, FIG. 8B) I₁(0°), (FIG. 8C) I₁ (60°), (FIG. 8D) I₂ (0°), (FIG. 8E) I₂ (60°) and (FIG. 8F) I₃ (0°), according to an embodiment. The scattering patterns are plotted as polar coordinates. The scattering angle θ, which is twice the value of reflection angle, has ranges from −180° to 180°. A θ value of 0° indicates normal reflection, while −180° or 180° indicates wavefields traveling in the same direction.

For consistent analysis with the scattering pattern used in FWI, a scattering angle θ may be defined as twice the value of reflection angle. A scattering pattern w(θ) describes the sensitivity of the RTM image to reflection events with different scattering angles.

The basic imaging condition assumes an isotropic scattering pattern wᵢₛₒ(θ)=1 for the scattering angles, as shown in FIG. 8A. The effect of scattering pattern on the RTM image can be viewed as a weight in the stacking:

$${I}_{iso} = {\sum }_{θ} {w}_{iso} ( θ ) I ( θ ) , where {w}_{iso} ( θ ) = 1 \qquad ( 2 )$$

where I(θ) represents the image of reflection events with scattering angle θ, which has a range from −180° to 180°. A θ value of 0° indicates normal reflection, while −180° or 180° indicates wavefields traveling in the same direction. Negative angles denote wavefields incident on the opposite side of normal line compared to positive angles. This scattering angle θ can also be expressed as a vector θ=(θ₁, θ₂), where θ₁ and θ₂ can represent the scattering and the azimuth angles, respectively.

### Fourier-Series Imaging Condition

Determining individual instances of I(θ) for each angle θ can be challenging or result in instability when directly stacking for angle gather purposes. The basic cross-correlation imaging condition lacks control over the weight for stacking image of reflection events from different angles. Here, the imaging condition is defined to involve temporal derivative/integration and spatial derivatives, similar to wavefield modeling phase, applied to the source- and receiver-side wavefields. In an embodiment, Fourier-series imaging condition proves that when the imaging condition is implemented properly, it allows for the implicit stacking of I(θ) with a desired pattern for angle gather purpose.

Aiming to form an RTM image I_{any} with the desired scattering pattern w_{any}(θ) implies:

$${I}_{any} = {\sum }_{θ} {w}_{any} ( θ ) I ( θ ) , \qquad ( 3 )$$

where the Fourier series of the scattering pattern w_{any}(θ) can be written as

$${w}_{any} ( θ ) = {a}_{0} + {\sum }_{n \geq 1} [ {a}_{n} cos ( n θ ) + {b}_{n} sin ( n θ ) ] . \qquad ( 4 )$$

By leveraging trigonometric identities, cos (nθ) and sin (nθ) can be rewritten solely in terms of cos (θ) and sin (θ), allowing w_{any} (θ) to be represented as:

$${w}_{any} ( θ ) = {\sum }_{n , m \geq 0} {w}_{n , m} {cos}^{n} ( θ ) {sin}^{m} ( θ ) . \qquad ( 5 )$$

Substituting Equation (5) into Equation (3) yields:

$${I}_{any} = {\sum }_{n , m \geq 0} {w}_{n , m} {\sum }_{θ} {cos}^{n} ( θ ) {sin}^{m} ( θ ) I ( θ ) . \qquad ( 6 )$$

With the w_{n,m} computed from w_{any}(θ) in Equation (5), the Fourier-series imaging condition for an RTM image I_{any} may be:

$${I}_{any} = \int ( {\sum }_{n , m \geq 0}^{N = n + m} {w}_{n , m} {I}_{{cos}^{( n )} {sin}^{( m )}} ) dt , \qquad ( 7 )$$

where I_{cos} (n)ₛᵢₙ (m) is defined as the Fourier-series terms in imaging conditions:

$${I}_{{cos}^{( n )} {sin}^{( m )}} = \int ( {V}_{p}^{2 N} {〈 {∇}_{( 90 ° )}^{( m )} {∇}^{( n )} {P}^{( N )} , {∇}^{( N )} {R}^{( N )} 〉}_{F} ) dt . \qquad ( 8 )$$

Equation (7) is denoted as Fourier-series imaging condition, where N=n+m is the Fourier-series order. Here, Vₚ=Vₚ(x) is the P-wave velocity model. The superscript N in P^{(N)} indicates that the wavefield P is time-integrated N times, ∇⁽ⁿ⁾ means spatial gradient operator applied n times. A subscript φ in

$${∇}_{( φ )}^{( m )} = {( M ( φ ) ∇ )}^{( n )}$$

represents the rotation angle, where M(φ) is the rotation matrix, thus ∇_{(φ)} is the spatial gradient in the rotated coordinate system. The Frobenius inner product [symbol] , [symbol] _{F} sums component-wise inner products between

$${∇}_{( 90 )}^{( m )} {∇}^{( n )} {P}^{( N )}$$

and ∇^{(N)} R^{(N)}.

The subscript cos⁽ⁿ⁾sin^{(m)} in I_{cos} (n)ₛᵢₙ (m) denotes that the plane-wave analytical solution can be proven using p to Equation (8) as:

$${I}_{{cos}^{( n )} {sin}^{( m )}} = {\sum }_{θ} {cos}^{( n )} {sin}^{( m )} ( θ ) I ( θ ) . \qquad ( 9 )$$

By substituting Equation (9) into Equation (7), the Fourier-series imaging condition is satisfied by Equation (6).

For 3D case, rotation angle is a vector φ=(φ₁, φ₂), and ∇_{(φ)}=∇_{(φ}_{₁}_{,φ}_{₂}₎=M(φ₁, φ₂)∇. The Fourier-series imaging condition for an RTM image is

$${I}_{any} = \int ( {\sum }_{n , m , p \geq 0}^{N = n + m + p} {w}_{n , m , p} {V}_{p}^{2 N} {〈 {∇}_{( 0 ° , 90 ° )}^{( p )} {∇}_{( 90 ° , 0 ° )}^{( m )} {∇}^{( n )} {P}^{( N )} , {∇}^{( N )} {R}^{( N )} 〉}_{F} ) dt . \qquad ( 10 )$$

The first spatial gradient applied to P and R can be replaced by source- and receiver-side particle velocities u and v, respectively:

$${∇}^{( N )} {P}^{( N )} = - ρ {∇}^{( N - 1 )} {u}^{( N - 1 )} and {∇}^{( N )} {R}^{( N )} = - ρ {∇}^{( N - 1 )} {v}^{( N - 1 )} , \qquad ( 11 )$$

where ρ is the density.

### Designing Fourier-Series Imaging Condition for Angle Gather Using Rotation

Equations (6) and (7) indicate that one can create their own Fourier series imaging condition for RTM by designing w_{any}(θ), computing its Fourier series coefficients in terms of cos (θ) and sin (θ), and substituting them into Equation (7). To create an angle gather containing multiple RTM images, multiple w_{any}(θ) s may be designed. To simplify this process, w_{any}(θ) for zero-angle Fourier-series imaging condition is sufficient, as the Fourier series imaging condition for other angles can be obtained by rotating the spatial gradient applied to the source- or receiver-side wavefields.

For simplicity, the acoustic impedance imaging condition may be adopted while holding velocity fixed, which falls under the 1^{st}-order Fourier-series imaging condition. It can be expressed as:

$${I}_{1} ( {0}^{∘} ) = \int 0.5 ( PR + {V}_{p}^{2} ∇ {P}^{( 1 )} \cdot ∇ {R}^{( 1 )} ) dt . \qquad ( 12 )$$

By decomposing source- and receiver-side wavefields in plane waves, it may be proven that:

$${I}_{1} ( 0 ° ) = {\sum }_{θ} {w}_{1} ( θ ) I ( θ ) , where {w}_{1} ( θ ) = 0.5 ( 1 + cos θ ) . \qquad ( 13 )$$

FIG. 8B illustrates the scattering pattern w₁ (θ), showing that the impedance imaging condition has zero sensitivity to backscattering, diving, and head waves, which has scattering angle −180° or 180°. The 0° in I₁(0°) indicates that acoustic impedance imaging condition assigns the largest weight to reflection events with a scattering angle θ=0°, with the weight decreasing for larger scattering angles.

An image condition for an RTM image can be converted into an image condition for an angle gather by properly rotating the spatial gradient ∇ for the source-side wavefield:

$${I}_{1} ( φ ) = \int 0.5 ( PR + {V}_{p}^{2} {∇}_{( φ )} {P}^{( 1 )} \cdot ∇ {R}^{( 1 )} ) dt . \qquad ( 14 )$$

As mentioned earlier, ∇_{(φ)}=M(φ)∇ is the spatial gradient in the rotated coordinate system. The scattering pattern for I₁ (φ) can be proven to be w₁(θ−φ):

$$\begin{matrix}{I}_{1} ( φ ) = {\sum }_{θ} {w}_{1} ( θ - φ ) I ( θ ) , \\ where {w}_{1} ( θ - φ ) = 0.5 [ 1 + cos ( θ - φ ) ] .\end{matrix} \qquad ( 15 )$$

The φ in I₁ (φ) implies that I₁ (φ) gives largest weight to reflection events with a scatter angle θ=φ, with the weight decreasing as θ deviates from φ. Thus, I₁ (φ) can be considered a low-angle-resolution angle gather. I₁ (0°) by acoustic impedance imaging condition in Equation (12) is the zero-angle image in I₁ (φ). The scattering pattern w₁ (θ−φ) may be displayed for the case φ=60° in FIG. 8C.

Generally, Fourier-series imaging condition that includes terms with a higher-order N yields a higher-angle-resolution angle gather. To demonstrate this, a 2^{nd}-order Fourier-series imaging condition may be designed as:

$${I}_{2} ( 0 ° ) = \int 0.5 ( {V}_{p}^{2} ∇ {P}^{( 1 )} \cdot ∇ {R}^{( 1 )} + {V}_{p}^{4} {〈 {∇}^{( 2 )} {P}^{( 2 )} , {∇}^{( 2 )} {R}^{( 2 )} 〉}_{F} ) dt . \qquad ( 16 )$$

Its scattering pattern w₂ (θ) is written as

$${I}_{2} ( 0 ° ) = {\sum }_{θ} {w}_{2} ( θ ) I ( θ ) , where {w}_{2} ( θ ) = 0.5 [ cos θ + {cos}^{2} ( θ ) ] . \qquad ( 17 )$$

FIG. 8D illustrates the scattering pattern w₂ (θ). Compared to the scattering pattern w₁ (θ) in FIG. 8B, the w₂ (θ) decreases more rapidly than w₁ (θ) with larger scattering angles. Thus, I₂ (0°) gives higher angle resolution centered at angle 0° than impedance imaging condition I₁(0°).

The spatial gradient ∇ for source-side wavefield is also rotated by an angle φ to transform the RTM image I₂ (0°) into an RTM angle gather I₂ (φ):

$${I}_{2} ( φ ) = \int 0.5 ( {V}_{p}^{2} {∇}_{( φ )} {P}^{( 1 )} \cdot ∇ {R}^{( 1 )} + {V}_{p}^{4} {〈 {∇}_{( φ )}^{( 2 )} {P}^{( 2 )} , {∇}^{( 2 )} {R}^{( 2 )} 〉}_{F} ) dt . \qquad ( 18 )$$

The scattering pattern for I₂ (φ) is proven to be w₂ (θ−φ):

$$\begin{matrix}{I}_{2} ( φ ) = {\sum }_{θ} {w}_{2} ( θ - φ ) I ( θ ) , \\ where {w}_{2} ( θ - φ ) = 0.5 [ cos ( θ - φ ) + {cos}^{2} ( θ - φ ) ] .\end{matrix} \qquad ( 19 )$$

The scattering pattern w₂ (θ−φ) may be illustrated for the case φ=60° in FIG. 8E.

The 3^{rd}-order Fourier-series imaging condition for angle gather can be quickly given by

$${I}_{3} ( φ ) = \int 0.5 ( {V}_{p}^{4} {〈 {∇}_{( φ )}^{( 2 )} {P}^{( 2 )} , {∇}^{( 2 )} {R}^{( 2 )} 〉}_{F} + {V}_{p}^{6} {〈 {∇}_{( φ )}^{( 3 )} {P}^{( 3 )} , {∇}^{( 3 )} {R}^{( 3 )} 〉}_{F} ) dt , \qquad ( 20 )$$

which has a scattering pattern:

$${w}_{3} ( θ - φ ) = 0.5 [ {cos}^{2} ( θ - ϕ ) + {cos}^{3} ( θ - φ ) ] , \qquad ( 21 )$$

as plotted in FIG. 8F for a case φ=0°. The angle resolution of this 3^{rd}-order Fourier-series imaging condition I₃(φ) further increases compared to the 2^{nd}-order one I₂ (φ) in FIG. 8D.

By applying a rotation matrix M(φ) to the spatial gradient of the source-side wavefield, a zero-angle Fourier-series imaging condition may be transformed into imaging conditions for an angle gather. A form of Fourier-series imaging condition with rotation may be:

$${I}_{N} ( φ ) = \int ( {\sum }_{N \geq 0} {w}_{N} {V}_{p}^{2 N} {〈 {∇}_{( φ )}^{( N )} {P}^{( N )} , {∇}^{( N )} {R}^{( N )} 〉}_{F} ) dt . \qquad ( 22 )$$

Compared this with the Fourier-series imaging condition without rotation in Equation (7), a fix scattering pattern for the angles, and an order of magnitude reduction in the number of Fourier-series terms, may be observed. Equation (22) is applicable to both 2D and 3D scenarios, depending on whether 2D or 3D rotation is employed.

Designing a Fourier-series imaging condition with rotation, even with same Fourier-series order, is an underdetermined problem, suggesting that different combinations of w_{N} exist. This rotation matrix M(φ) can also be applied on the spatial gradient of the receiver-side wavefield, or even both wavefields, as long as their angle difference for two rotations remains equal to φ.

Fourier-Series Imaging Condition with Reciprocity for Elastic Imaging Condition and Beyond

The scattering angle φ has negative values and can also represent a vector for an angle gather of reflection and azimuth angles. This indicates that Fourier-series imaging condition can be intricate for generating an angle gather solely as a function of a scalar reflection angle. To solve this problem, the Fourier-series imaging condition may be simplified by assuming reciprocity:

$$I ( - θ = I ( θ ) . \qquad ( 23 )$$

Reciprocity holds because the reflection coefficient remains consistent regardless of whether the incident wave approaches from one side or the other of the normal plane or different azimuths. This leads to the Fourier-series imaging condition that holds reciprocity, denoted as

$${I}_{any}^{r} ( φ ) : {I}_{any}^{r} ( φ ) = 0.5 [ {I}_{any} ( - φ ) + {I}_{any} ( φ ) ] . \qquad ( 24 )$$

Applying reciprocity to I₂ (φ) in Equation (18) yields

$${I}_{2}^{r} ( φ ) = 0.5 [ {sin}^{2} ( φ ) PR + cos ( φ ) {V}_{p}^{2} ∇ {P}^{( 1 )} \cdot ∇ {R}^{( 1 )} + [ {cos}^{2} ( φ ) - {sin}^{2} ( φ ) ] {V}_{p}^{4} {〈 {∇}^{( 2 )} {P}^{( 2 )} , {∇}^{( 2 )} 〉}_{F} ] . \qquad ( 25 )$$

The equation can also be expressed using particle velocities as:

$${I}_{2}^{r} ( φ ) = 0.5 [ {sin}^{2} ( φ ) PR + cos ( φ ) {ρ}^{2} {V}_{p}^{2} u \cdot v + [ {cos}^{2} ( φ ) - {sin}^{2} ( φ ) ] {ρ}^{2} {V}_{p}^{4} {〈 ∇ {u}^{( 1 )} , ∇ {v}^{( 1 )} 〉}_{F} ] . \qquad ( 26 )$$

Utilizing reciprocity eliminates the need to rotate the spatial gradient and uses a scalar for scattering angle φ, even in 3D scenarios.

The 2^{nd}-order Fourier-series imaging condition with reciprocity in Equations (25) and (26) actually employs elastic imaging principles, as its three terms—PR, ∇⁽¹⁾ p⁽¹⁾. ∇⁽¹⁾ R⁽¹⁾ and [symbol] ∇⁽²⁾ p⁽²⁾, ∇⁽²⁾ R⁽²⁾ [symbol] , or PR, u·v and [symbol] ∇u⁽¹⁾, ∇v⁽¹⁾ [symbol] _{F}—are directly linked to the gradients of three elastic parameters in EFWI. This approach may be designated as elastic imaging condition for a RTM angle gather, which combines these three terms following specific functions of the angle φ. The term “elastic” is solely for imaging condition, but the wavefield modeling phase can use an acoustic propagator.

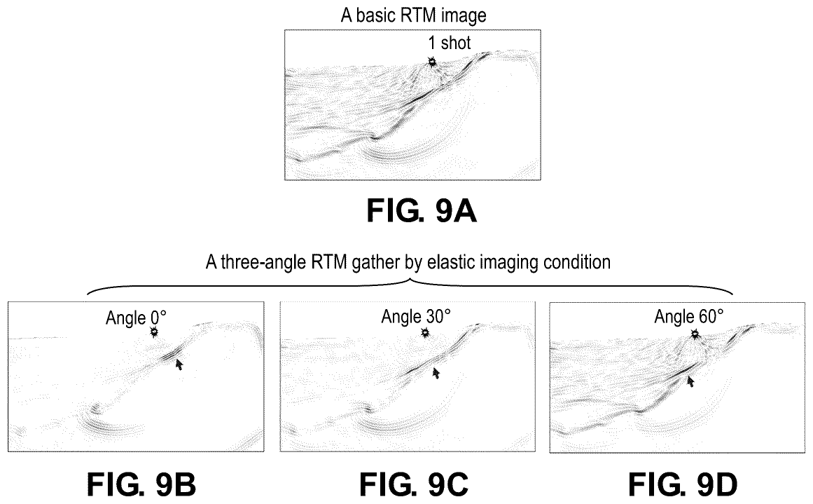

To illustrate this concept, a 2D section of the SEAM I model may be utilized. FIG. 9A illustrates the basic RTM image produced from a single shot, while FIGS. 9B-9D illustrate a RTM angle gather of three chosen angles, computed by inserting φ=0°, 30° and 60° into Equations (25) or (26), according to an embodiment.

Reciprocity may be applied to the 3^{rd}-order Fourier-series imaging condition I₃ (φ) in Equation (20), resulting in:

$${I}_{2}^{r} ( φ ) = 0.5 [ {sin}^{2} ( φ ) PR + 3 cos ( φ ) {sin}^{2} ( φ ) {V}_{p}^{2} ∇ {P}^{( 1 )} \cdot ∇ {R}^{( 1 )} + [ {cos}^{2} ( φ ) - {sin}^{2} ( φ ) ] {V}_{p}^{4} {〈 {∇}^{( 2 )} {P}^{( 2 )} , {∇}^{( 2 )} {R}^{( 2 )} 〉}_{F} + [ {cos}^{3} ( φ ) - 3 cos ( φ ) ] {V}_{p}^{6} {〈 {∇}^{( 3 )} {P}^{( 3 )} , {∇}^{( 3 )} {R}^{( 3 )} 〉}_{F} . \qquad ( 25 )$$

This 3^{rd}-order or higher Fourier-series imaging condition with reciprocity surpasses the angle resolution of elastic parameters.

Applying reciprocity to Fourier-series imaging condition eliminates the need to rotate the spatial gradient as in Equation (22). The variable w_{N} becomes a function of angle w_{N}=w_{N} (φ). The Fourier-series imaging condition with reciprocity can be expressed as:

$${I}_{N}^{r} ( φ ) = \int ( {\sum }_{N \geq 0} {w}_{N} ( φ ) {V}_{p}^{2 N} {〈 {∇}^{( N )} {P}^{( N )} , {∇}^{( N )} {R}^{( N )} 〉}_{F} ) dt . \qquad ( 28 )$$

Equation (28) is a function a scalar scattering angle φ, applicable even in 3D scenarios. Designing a Fourier-series imaging condition with reciprocity is an underdetermined problem, suggesting that multiple combinations of ∇ₚ^{2N} [symbol] ∇^{(N)} p^{(N)}, ∇^{(N)} R^{(N)} [symbol] _{F} following specific w_{N}(φ) may exist.

### Workflow Summary for Generating Angle Gather Using Fourier-Series Imaging Condition

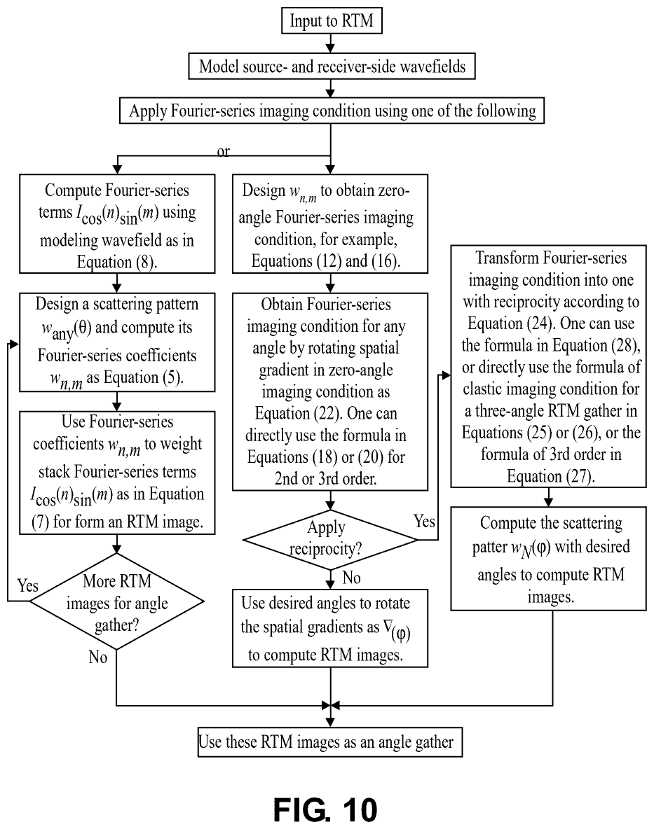

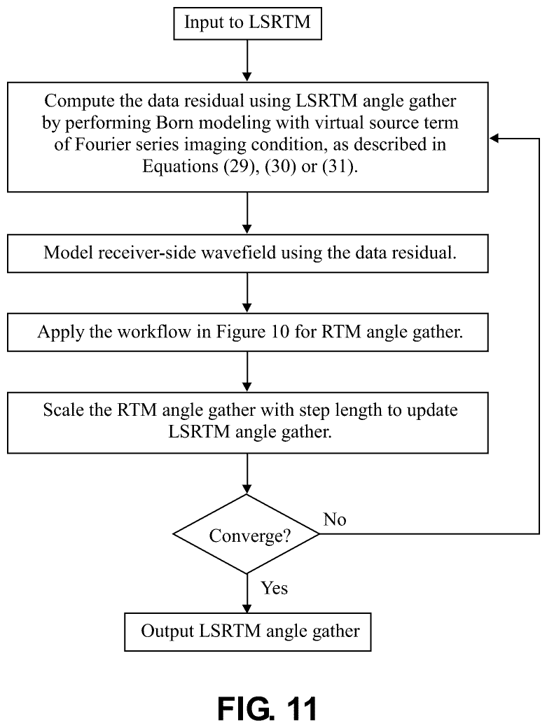

FIG. 10 illustrates a workflow for Fourier-series imaging condition for RTM angle gather, according to an embodiment. More particularly, a workflow of computing RTM angle gathers using Fourier-series imaging condition and its simplified forms using rotation or reciprocity are shown FIG. 10.

The RTM image can be utilized in the virtual source term in Born modeling for least-square RTM (LSRTM), allowing for iterative updates of the image until a good match is achieved between the modeled and observed data. Following the adjoint-state method, the virtual source term for Fourier series imaging condition in Equation (8) may be:

$${S}_{any} = {\sum }_{n , m \geq 0}^{N = n + m} {w}_{n , m} {V}_{p}^{2 N} {〈 {∇}^{( N )} , {[ {I}_{any} {∇}_{( 9 {0}^{∘} )}^{( m )} {∇}^{( n )} {P}^{( N )} ]}^{( N )} 〉}_{F} , \qquad ( 29 )$$

where the product of RTM image I_{any} and every component of

$${∇}_{( 9 {0}^{∘} )}^{( m )} {∇}^{( n )} {P}^{( N )}$$

is computed, followed by time integration N times as indicated by the superscript N in [ ]^{(N)}, before applying the Frobenius inner product [symbol] , [symbol] F. Additionally, the virtual source term for Fourier series imaging condition with rotation in Equation (22) may be:

$${S}_{N} ( φ ) = {\sum }_{n , m \geq 0}^{N = n + m} {w}_{N} {V}_{p}^{2 N} {〈 {∇}^{( N )} , {[ {I}_{N} ( φ ) {∇}_{( φ )}^{( N )} {P}^{( N )} ]}^{( N )} 〉}_{F} . \qquad ( 30 )$$

The virtual source term for the Fourier series imaging condition with reciprocity in Equation (28) is given by:

$${S}_{N}^{r} ( φ ) = {\sum }_{n , m \geq 0}^{N = n + m} {w}_{N} ( φ ) {V}_{p}^{2 N} {〈 {∇}^{( N )} , {[ {I}_{N}^{r} ( φ ) {∇}^{( N )} {P}^{( N )} ]}^{( N )} 〉}_{F} . \qquad ( 31 )$$

Similar to how the order is defined in Fourier series imaging condition, when the virtual source term uses 3^{rd} order or higher order, it models a wavefield that surpasses the angle resolution of the elastic wavefield.

FIG. 11 illustrates a workflow for LSRTM angle gather using Fourier-series imaging condition, according to an embodiment.

### Designing Elastic Parameterization for EFWI

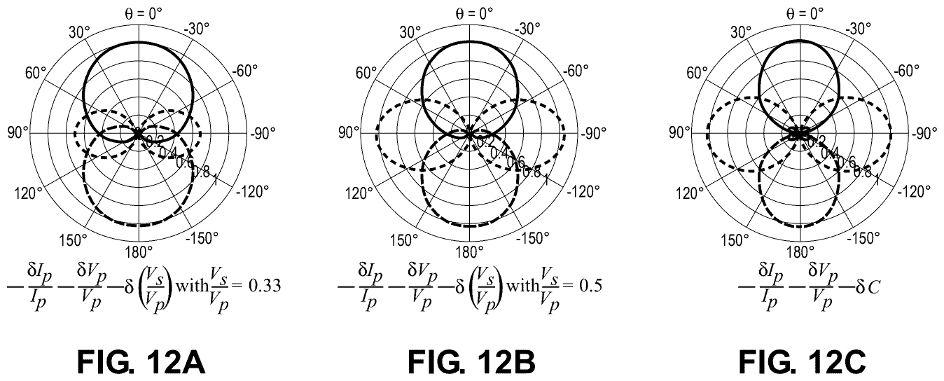

FIGS. 12A-12C illustrate a PP scattering pattern of elastic parameterization (FIG. 12A)

$$( \frac{δ {I}_{p}}{{I}_{p}} , \frac{δ {V}_{p}}{{V}_{p}} , δ ( \frac{{V}_{s}}{{V}_{p}} ) ) with \frac{{V}_{s}}{{V}_{p}} = 0.33 ,$$

### (FIG. 12B)

$$( \frac{δ {I}_{p}}{{I}_{p}} , \frac{δ {V}_{p}}{{V}_{p}} , δ ( \frac{{V}_{s}}{{V}_{p}} ) ) with \frac{{V}_{s}}{{V}_{p}} = 0.5 ,$$

and (FIG. 12C) proposed elastic parameterization

$$( \frac{δ {I}_{p}}{{I}_{p}} , \frac{δ {V}_{p}}{{V}_{p}} , δ C ) ,$$

according to an embodiment. In determining an elastic parameterization for EFWI, a criterion is to minimize parameters trade-off, which ensures that the scattering patterns of each parameter do not significantly overlap across scattering angles. One of the optimal parameterizations can be

$$( {I}_{p} , {V}_{p} , \frac{{V}_{s}}{{V}_{p}} ) .$$

The variable δ is denoted as parameter perturbation, and the analytical PP scattering pattern for

$$( \frac{δ {I}_{p}}{{I}_{p}} , \frac{δ {V}_{p}}{{V}_{p}} , δ ( \frac{{V}_{s}}{{V}_{p}} ) )$$

is given by:

$$P ( θ ) \sim \frac{{ω}^{2}}{{V}_{p}^{2}} [ ( \frac{1}{2} + \frac{1}{2} cos ( θ ) - \frac{{V}_{s}^{2}}{{V}_{p}^{2}} {sin}^{2} ( θ ) ) \frac{δ {I}_{p}}{{I}_{p}} + ( \frac{1}{2} - \frac{1}{2} cos ( θ ) - \frac{{V}_{2}^{2}}{{V}_{p}^{2}} {sin}^{2} ( θ ) ) \frac{δ {V}_{p}}{{V}_{p}} - 2 {sin}^{2} ( θ ) \frac{{V}_{s}}{{V}_{p}} δ ( \frac{{V}_{s}}{{V}_{p}} ) ] , \qquad ( 32 )$$

where its PP scattering pattern for

$$\frac{δ {I}_{p}}{{I}_{p}} = \frac{δ {V}_{p}}{{V}_{p}} = δ ( \frac{{V}_{s}}{{V}_{p}} ) is \frac{{V}_{s}}{{V}_{p}} = 0.33$$

and 0.5, respectively. The parameterization is not perfect due to two reasons: its dependence on the background

$$\frac{{V}_{s}}{{V}_{p}}$$

value, and the overlapping between

$$\frac{δ {I}_{p}}{{I}_{p}} and \frac{δ {V}_{p}}{{V}_{p}}$$

is not minimized. Since imaging condition can be considered as the adjoint of the modeling process, it may be determined that scattering patterns for elastic parameters are a combination of three terms 1, cos (θ), and cos²(θ). Thus, the method designs desired a scattering pattern that is the combination of these three terms, and then derives the corresponding elastic parameterization. For example, a new parameterization (δA, δB, δC) with a scattering pattern may be:

$$P ( θ ) \sim \frac{{ω}^{2}}{{V}_{p}^{2}} [ ( \frac{1}{2} {cos}^{2} ( θ ) + \frac{1}{2} cos ( θ ) ) δ A + ( \frac{1}{2} {cos}^{2} ( θ ) - \frac{1}{2} cos ( θ ) ) δ B + {sin}^{2} ( θ ) δ C ] . \qquad ( 33 )$$

A parameterization that satisfies such this designed scattering pattern may be:

$$\begin{matrix}( δ A , δ B , δ C ) = ( \frac{δ {I}_{p}}{{I}_{p}} , \frac{δ {V}_{p}}{{V}_{p}} , δ C ) , \\ where δ C = - δ {( \frac{{V}_{s}}{{V}_{p}} )}^{2} - [ {( \frac{{V}_{s}}{{V}_{p}} )}^{2} - 0 \text{.5} ] ( \frac{δ {I}_{p}}{{I}_{p}} + \frac{δ {V}_{p}}{{V}_{p}} )\end{matrix} \qquad ( 34 )$$

Forming a parameterization for even the same scattering pattern in Equation (33) is an underdetermined problem, suggesting that multiple solutions may exist. The scattering patterns of

$$\frac{δ {I}_{p}}{{I}_{p}} and \frac{δ {V}_{p}}{{V}_{p}}$$

in elastic parameterization

$$( \frac{δ {I}_{p}}{{I}_{p}} , \frac{δ {V}_{p}}{{V}_{p}} , δ ( \frac{{V}_{s}}{{V}_{p}} ) )$$

are different from in parameterization

$$( \frac{δ {I}_{p}}{{I}_{p}} , \frac{δ {V}_{p}}{{V}_{p}} , δ C )$$

because they hold different other parameters fixed.

The previous new parameterization demonstrates that one can first design the desired radiation pattern to minimize parameter trade-offs and then determine the corresponding elastic parameterization. For elastic parameterization of other purposes, a systematic approach may be used to design and obtain the parameterization by formulating the problems as finding a generalized parameterization (δA, δB, δC) that corresponds to three target radiation patterns expressed as combination of the terms 1, cos θ, and cos²θ. The formulation is given by:

$$P ( θ ) \sim \frac{{ω}^{2}}{{V}_{p}^{2}} [ ( {w}_{0}^{A} + {w}_{1}^{A} cos θ + {w}_{2}^{A} {cos}^{2} θ ) δ A + ( {w}_{0}^{B} + {w}_{1}^{B} cos θ + {w}_{2}^{B} {cos}^{2} θ ) δ B + ( {w}_{0}^{B} + {w}_{1}^{B} cos θ + {w}_{2}^{B} {cos}^{2} θ ) SC ] . \qquad ( 35 )$$

where

$${w}_{0 / 1 / 2}^{A / B / C}$$

are weights that control the radiation patterns for elastic parameterization. The radiation pattern matrix W may be defined as:

$$W = [ \begin{matrix}{w}_{0}^{A} & {w}_{0}^{B} & {w}_{0}^{C} \\ {w}_{1}^{A} & {w}_{1}^{B} & {w}_{1}^{C} \\ {w}_{2}^{A} & {w}_{2}^{B} & {w}_{2}^{C}\end{matrix} ] . \qquad ( 36 )$$

Thus, the generalized elastic parameterization (δA, δB, δC) may be derived as:

$${( δ A , δ B , δ C )}^{T} = {W}^{- 1} {( \frac{δλ}{λ + 2 μ} , \frac{δ ρ}{ρ} , \frac{2 δμ}{λ + 2 μ} )}^{T} . \qquad ( 37 )$$

Next, the generalized elastic parameterization may be utilized in elastic FWI. Again, the explicit determination and update of (δA, δB, δC) may be omitted. The variable gₓ may denote the FWI gradient for model parameter x. Assuming that the gradient for parameterization

$$( \frac{δ λ}{λ + 2 μ} \frac{δ ρ}{ρ} , \frac{2 δμ}{λ + 2 μ} )$$

has been computed, the gradient transform to (δA, δB, δC) may be given by:

$${( {g}_{δ A} , {g}_{δ B} , {g}_{δ C} )}^{T} = {{W}^{T} ( {g}_{\frac{δ λ}{λ + 2 μ}} , {g}_{\frac{δ ρ}{ρ}} , {g}_{\frac{2 δμ}{λ + 2 μ}} )}^{T} . \qquad ( 38 )$$

The corresponding update for (δA, δB, δC) is:

$${( δ A , δ B , δ C )}^{T} = {α ( {g}_{δ A} , {g}_{δ B} , {g}_{δ C} )}^{T} , \qquad ( 39 )$$

where α represents the step length. At every iteration, (δA, δB, δC) is transformed back into updates of the conventional elastic parameters as:

$${( \frac{δ λ}{λ + 2 μ} , \frac{δ ρ}{ρ} , \frac{2 δμ}{λ + 2 μ} )}^{T} = α {W ( δ A , δ B , δ C )}^{T} . \qquad ( 40 )$$

The full transform for a generalized parameterization (Equation (37), its gradient computation (Equation (38), and the corresponding model update (Equations (39) to (40)) can be combined into a single step:

$${( \frac{δ λ}{λ + 2 μ} , \frac{δ ρ}{ρ} , \frac{2 δμ}{λ + 2 μ} )}^{T} = α {{WW}^{T} ( {g}_{\frac{δ λ}{λ + 2 μ}} , {g}_{\frac{δ ρ}{ρ}} , {g}_{\frac{2 δμ}{λ + 2 μ}} )}^{T} . \qquad ( 41 )$$

The equation further genderizes the impact of elastic parameterization on elastic model update, demonstrating that elastic parameterization acts as a WW^{T} radiation pattern preconditioning on the FWI gradients for updating the corresponding elastic parameters. Forming a parameterization for a certain radiation pattern is an underdetermined problem. For example, choosing different initial parameterizations-such as more commonly used (Vₚ, Vₛ, ρ) for FWI input, can result in a different expression:

$$( \begin{matrix}\begin{matrix}δ A \\ δ B\end{matrix} \\ δ C\end{matrix} ) = {W}^{- 1} [ \begin{matrix}2 & 1 - 2 \frac{{V}_{s}^{2}}{{V}_{p}^{2}} & - 4 \frac{{V}_{s}^{2}}{{V}_{p}^{2}} \\ 0 & 1 & 0 \\ 0 & 2 \frac{{V}_{s}^{2}}{{V}_{p}^{2}} & 4 \frac{{V}_{s}^{2}}{{V}_{p}^{2}}\end{matrix} ] ( \begin{matrix}\begin{matrix}\frac{δ {V}_{p}}{{V}_{p}} \\ \frac{δρ}{ρ}\end{matrix} \\ \frac{δ {V}_{s}}{{V}_{s}}\end{matrix} ) . \qquad ( 42 )$$

The expression is likely more convenient to use due to conventional FWI input/output practices. However, model convergence is determined by radiation patterns, meaning Equation (42) exhibits the same convergence behavior as Equation (37).
Workflow of Elastic Parameterization with Fourier-Series Imaging Condition in EFWI

The gradient of a designed parametrization can be obtained using gradient transform by chain rule. Alternatively, one can utilize the corresponding Fourier-series imaging conditions to compute the gradient. For example, the FWI gradients for

$$\frac{δ {I}_{p}}{{I}_{p}} , \frac{δ {V}_{p}}{{V}_{p}}$$

and δC can be computed using

$${I}_{2}^{r}$$

(0°),

$${I}_{2}^{r}$$

(180°) and

$${I}_{2}^{r}$$

(90°), respectively, from the elastic imaging condition for a RTM angle gather in Equations (25) and (26).

After computing EFWI gradients for the new elastic parametrization, the parameter perturbations may be determined by simply scaling the gradients with a step length. After that, the parameter perturbations can be transformed into perturbations of commonly used elastic parameters like (δVₚ, δVₛ, δρ) for the model update. Upon convergence, the inverted three parameters can be converted to an angle gather by taking their directional derivatives. Alternatively, reflectivity can be computed from (Vₚ, Vₛ, ρ) using reflectivity formulas like the Shuey's equation or the Zoeppritz equation.

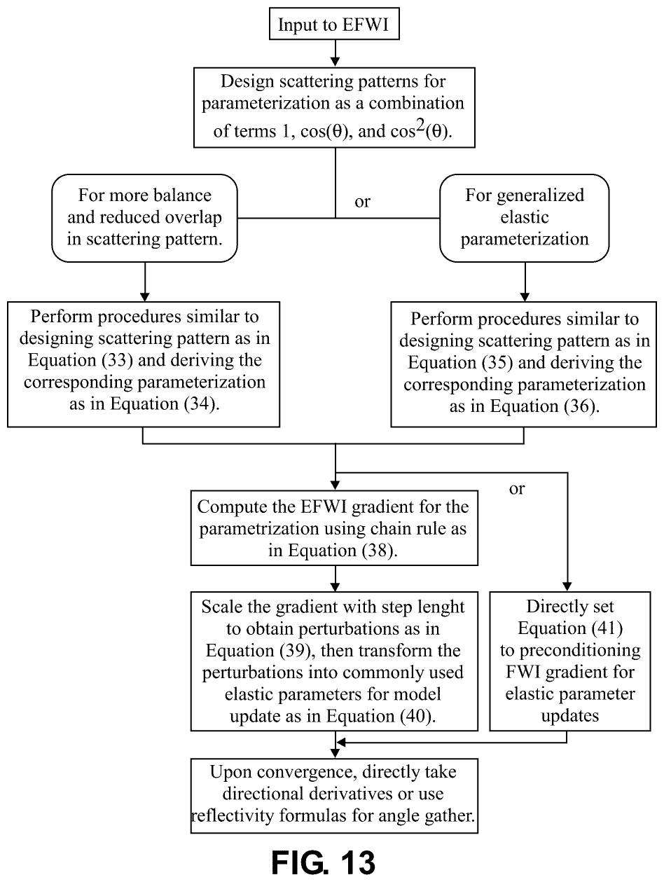

FIG. 13 illustrates elastic parameterization using Fourier-series imaging condition and applying it in EFWI, according to an embodiment.

### Surpass the Angle Resolution of Elastic Parameters

In the previous sections, the 3^{rd}-order or higher Fourier-series imaging condition for RTM and the virtual-source term for LSRTM are described, both of which surpass the angle resolution limitations of elastic parameters, as shown in Equations (28) and (31), respectively. However, EFWI is constrained to 2nd-order angle resolution due to its handling of elastic parameters.

To enhance the angle resolution of EFWI, virtual source terms from LSRTM may be incorporated into the conventional elastic wave equation. The conventional elastic wave equation in EFWI is:

$$ℒ ( P , {V}_{p} , {V}_{s} , ρ ) = S , \qquad ( 43 )$$

where P represents the elastic wavefield, and S is the source. To introduce enhanced angle resolution, a perturbed wavefield δP computed using virtual source terms

$${S}_{N}^{r}$$

(φ) from Equation (31) may be introduced, but with the restriction that orders smaller than 2 are excluded:

$$ℒ ( δ P , {V}_{p} , {V}_{s} , ρ ) = {S}_{N}^{r} ( φ ) , where n + m > 3 in {S}_{N}^{r} ( φ ) . \qquad ( 44 )$$

Here, the combined wavefield P+δP surpasses the angle resolution of conventional elastic wavefield P.

Alternatively, the virtual source terms

$${S}_{N}^{r}$$

(φ) can be directly augmented into the Equation (43) as:

$$ℒ ( {P}_{a u g} , {V}_{p} , {V}_{s} , ρ ) + {S}_{N}^{r} ( φ ) = S , where n + m > 3 in {S}_{N}^{r} ( φ ) . \qquad ( 45 )$$

Here, the augmented wavefield P_{aug} also surpasses the angle resolution of conventional elastic wavefield P.

The workflow of EFWI with enhanced angle resolution remains similar to the conventional EFWI workflow. However, Equations (44) or (45) replace Equation (43) in the wavefield modeling phase, and an additional term I_{N} (φ) is updated along with elastic parameters in the imaging condition phase.

### Wavenumber-Domain Expression

The imaging condition, including the Fourier-series imaging, may use temporal derivative/integration and spatial derivatives, which can be reformulated in the wavenumber domain. For instance, the Vₚ∇P⁽¹⁾ (x, y, z) that is repeatedly applied in Fourier series imaging condition can be expressed in the wavenumber domain as

$${V}_{p} ∇ {P}^{( 1 )} ( x , y , z ) = {( {ℱ}^{- 1} [ \frac{{k}_{x}}{k} P ( {k}_{x} , {k}_{x} , {k}_{z} ) ] , {ℱ}^{- 1} [ \frac{{k}_{y}}{k} P ( {k}_{x} , {k}_{x} , {k}_{z} ) ] , {ℱ}^{- 1} [ \frac{{k}_{z}}{k} P ( {k}_{x} , {k}_{x} , {k}_{z} ) ] )}^{T} , \qquad ( 46 )$$

$$where$$

$$P ( {k}_{x} , {k}_{x} , {k}_{z} ) = ℱ [ P ( x , y , z ) ] , and k = \sqrt{{k}_{x}^{2} + {k}_{y}^{2} + {k}_{z}^{2}} .$$

In this equation, [symbol] and [symbol] ⁻¹ are the spatial Fourier transform and its inverse, respectively, and P(kₓ, kₓ, k_{z}) is P(x, y, z) in wavenumber domain. Utilizing a Fourier transform or other transformations that approximate this expression can serve as an alternative to the temporal derivative/integration and spatial derivatives in Fourier series imaging condition.

Compared to other conventional methods, which compute angle gathers in the wavenumber domain, the Fourier series imaging condition described herein takes a different approach. It first computes the Fourier-series terms independently before combining them into an angle gather. The method thus avoids the expensive wavenumber convolution of source- and receiver-side wavefields used for angle binning. Instead, the computational cost is shifted towards computing high-order Fourier-series terms for a high-angle-resolution angle gather.

### Exemplary Method

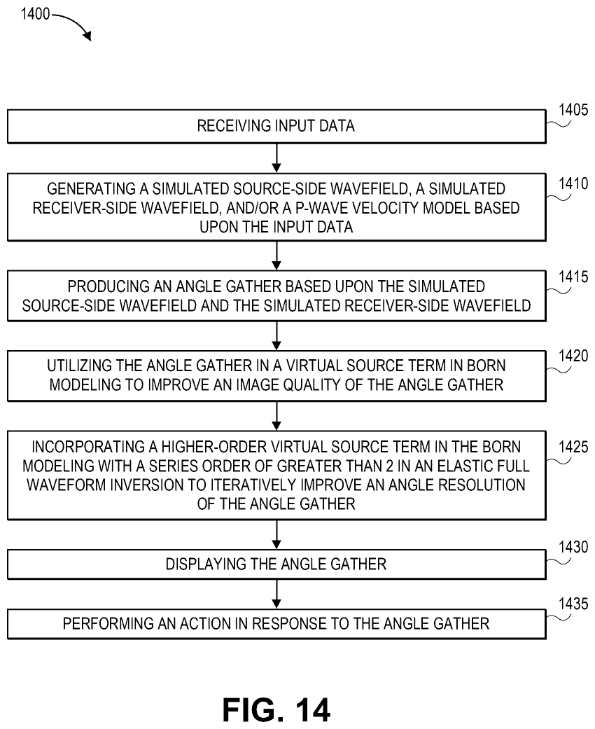

FIG. 14 illustrates a flowchart of a method 1400 for performing seismic imaging of a subsurface formation, according to an embodiment. An illustrative order of the method 1400 is provided below; however, one or more portions of the method 1400 may be performed in a different order, simultaneously, repeated, or omitted. At least a portion of the method 1400 may be performed with a computing system.

The method 1400 may include receiving input data, as at 1405. The input data may be or include seismic data. The seismic data may be or include seismic waves travelling through the subsurface formation.

The method 1400 may also include generating a simulated source-side wavefield, a simulated receiver-side wavefield, and/or a P-wave velocity model based upon the input data, as at 1410. The simulated source-side wavefield is a forward simulation of the seismic waves, and the simulated receiver-side wavefield is a backward simulation of the seismic waves. The P-wave velocity model may be generated using seismic tomography and full waveform inversion (FWI).

The method 1400 may also include producing an angle gather based upon the simulated source-side wavefield and the simulated receiver-side wavefield, as at 1415. The angle gather may be or include a plurality of subsurface images having different reflection angles. The angle gather may be produced by constructing Fourier-series terms based upon the simulated source-side wavefield, the simulated receiver-side wavefield, and/or the P-wave velocity model. The Fourier-series terms may be constructed in a Fourier-series imaging condition by applying different orders of time integrations and/or spatial gradients to the simulated source-side wavefield and/or the simulated receiver-side wavefield (e.g., before they are combined in the Fourier-series imaging condition). The Fourier-series imaging condition may be used to construct the subsurface images. The Fourier-series imaging condition may be determined based upon the simulated source-side wavefield and the simulated receiver-side wavefield.

The angle gather may also be produced by determining Fourier-series coefficients based upon a scattering pattern. The scattering pattern may be determined based upon weight stacking of the subsurface images with different reflection angles. The angle gather may also be produced by weight stacking the Fourier-series terms using the Fourier-series coefficients to produce the angle gather.

Rotation and/or reciprocity may be applied to the Fourier-series imaging condition. In an example, in response to rotation being applied to the Fourier-series imaging condition, the rotation effectively transforms one of the subsurface images having a zero reflection angle into the subsurface images with the different reflection angles by rotating the spatial gradients in the Fourier-series imaging condition. In another example, in response to reciprocity being applied to the Fourier-series imaging condition and a series order of the Fourier-series term being set to 2, the Fourier-series imaging condition is considered to be an elastic imaging condition for generating a reverse time migration angle gather. In yet another example, in response to reciprocity being applied to the Fourier-series imaging condition and the series order of the Fourier-series term being set to be greater than 2, the Fourier-series imaging condition generates the reverse time migration angle gather with an angle resolution that is greater than an angle resolution achieved by the elastic imaging condition.

The method 1400 may also include utilizing the angle gather (e.g., in a virtual source term in Born modeling) to improve an image quality of the angle gather, as at 1420. The angle gather may be utilized according to an adjoint of the Fourier-series imaging condition for a least-square reverse time migration, which iteratively improves the image quality of the angle gather. The virtual source term may utilize the angle gather as a source in the Born modeling. The Born modeling linearizes a seismic wave equation that uses the virtual source term to re-radiate the simulated source-side wavefield.

The method 1400 may also include incorporating a higher-order virtual source term in the Born modeling with the series order of greater than 2 in an elastic full waveform inversion to iteratively improve an angle resolution of the angle gather, as at 1425.

The method 1400 may also include displaying the angle gather, as at 1430. This may include displaying the angle gather with the improved image quality and/or the improved angle resolution.

The method 1400 may also include performing an action based upon and/or in response to the angle gather, as at 1435. The action may be or include generating and/or transmitting a signal (e.g., using a computing system) that instructs or causes a physical action to occur (e.g., at a wellsite). The action may also or instead include performing the physical action. The physical action may include selecting where to drill a wellbore, drilling the wellbore, varying a weight and/or torque on a drill bit that is drilling the wellbore, determining a location and/or amount of hydrocarbons in the subsurface formation and then varying a drilling trajectory of the wellbore toward the hydrocarbons, varying a concentration and/or flow rate of a fluid pumped into the wellbore, or the like.

### SUMMARY

The method may construct Fourier-series terms in imaging condition using temporal derivative/integration and spatial derivatives. The method may generate an RTM image by weighting stack the Fourier-series terms using Fourier-series coefficients of a scattering pattern. For an angle gather, Fourier-series coefficients of different scattering patterns are used for weighting stack. The method may simplify Fourier-series imaging condition by rotating the spatial gradient. The rotation effectively transforms a zero-angle imaging condition into an imaging condition for any angle. The method may use 2nd-, 3rd- or higher-order Fourier-series imaging conditions with rotation. The method may simplify the Fourier-series imaging condition by applying reciprocity. With reciprocity, the number of Fourier-series terms is reduced, and a scalar as function of angle can be employed for angle gather computations. The method may utilize elastic imaging condition for an RTM angle gather, and surpass the angle resolution of elastic imaging condition. The method may use 2nd-, 3rd- or higher-order Fourier-series imaging conditions with reciprocity. The method may determine the virtual source term in Born modeling for LSRTM angle gather with Fourier-series imaging condition.

The method may conduct the elastic parameterization in EFWI based on desired scattering patterns. The method may conduct elastic parameterization with scattering pattern that are more balanced and exhibit less overlap. The method may conduct elastic parameterization by using radiation pattern as a preconditioning on the EFWI gradients. The method may incorporate higher-order Fourier-series terms in EFWI to surpass the angle resolution of elastic parameters. The method may use transformations of a wavenumber expression for temporal derivative/integration and spatial derivatives for the Fourier-series imaging condition. The method may utilize Fourier-series imaging condition RTM angle gather. The method may be or include an LSRTM workflow that utilizes Fourier-series imaging condition for LSRTM angle gather. The method may utilize inverted elastic parameterization for angle gathers or reflectivity computation.

The foregoing description, for purposes of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to explain the principles of the invention and its practical applications, to thereby enable others skilled in the art to utilize the invention and various embodiments with various modifications as are suited to the particular use contemplated.

The invention claimed is:

1. A method for performing seismic imaging of a subsurface formation, the method comprising:
receiving input data;
generating a simulated source-side wavefield and a simulated receiver-side wavefield based upon the input data;
producing an angle gather based upon the simulated source-side wavefield and the simulated receiver-side wavefield; and
utilizing the angle gather in a virtual source term in Born modeling to improve an image quality of the angle gather.

2. The method of claim 1, wherein the angle gather comprises a plurality of subsurface images having different reflection angles.

3. The method of claim 1, wherein the angle gather is produced by constructing Fourier-series terms based upon the simulated source-side wavefield and the simulated receiver-side wavefield, wherein the Fourier-series terms are constructed in a Fourier-series imaging condition by applying different orders of time integrations and spatial gradients to the simulated source-side wavefield and the simulated receiver-side wavefield before they are combined in the Fourier-series imaging condition, wherein the Fourier-series imaging condition is used to construct the subsurface images, and wherein the Fourier-series imaging condition is determined based upon the simulated source-side wavefield and the simulated receiver-side wavefield.

4. The method of claim 3, wherein the angle gather is also produced by determining Fourier-series coefficients based upon a scattering pattern, wherein the scattering pattern is determined based upon weight stacking of the subsurface images with different reflection angles.

5. The method of claim 4, wherein the angle gather is also produced by weight stacking the Fourier-series terms using the Fourier-series coefficients to produce the angle gather.

6. The method of claim 3, wherein the angle gather is utilized according to an adjoint of the Fourier-series imaging condition for a least-square reverse time migration, which iteratively improves the image quality of the angle gather.

7. The method of claim 1, wherein the virtual source term utilizes the angle gather as a source in the Born modeling.

8. The method of claim 1, wherein the Born modeling linearizes a seismic wave equation that uses the virtual source term to re-radiate the simulated source-side wavefield.

9. The method of claim 1, further comprising displaying the angle gather.

10. The method of claim 1, further comprising performing a physical action in response to the angle gather, and wherein the physical action comprises selecting where to drill a wellbore, drilling the wellbore, varying a weight and/or torque on a drill bit that is drilling the wellbore, determining a location and/or amount of hydrocarbons in the subsurface formation and then varying a drilling trajectory of the wellbore toward the hydrocarbons, varying a concentration and/or flow rate of a fluid pumped into the wellbore, or a combination thereof.

11. A computing system, comprising:
one or more processors; and
a memory system comprising one or more non-transitory computer-readable media storing instructions that, when executed by at least one of the one or more processors, cause the computing system to perform operations, the operations comprising:
receiving input data, wherein the input data comprises seismic data, and wherein the seismic data comprises seismic waves travelling through the subsurface formation;
generating a simulated source-side wavefield, a simulated receiver-side wavefield, and a P-wave velocity model based upon the input data;
producing an angle gather based upon the simulated source-side wavefield and the simulated receiver-side wavefield, wherein the angle gather comprises a plurality of subsurface images having different reflection angles, and wherein the angle gather is produced by constructing Fourier-series terms in a Fourier-series imaging condition; and
utilizing the angle gather in a virtual source term in Born modeling to improve an image quality of the angle gather, wherein the angle gather is utilized according to an adjoint of the Fourier-series imaging condition for a least-square reverse time migration, which iteratively improves the image quality of the angle gather.

12. The computing system of claim 11, wherein in response to rotation being applied to the Fourier-series imaging condition, the rotation effectively transforms one of the subsurface images having a zero reflection angle into the subsurface images with the different reflection angles by rotating spatial gradients in the Fourier-series imaging condition.

13. The computing system of claim 11, wherein in response to reciprocity being applied to the Fourier-series imaging condition and a series order of the Fourier-series terms being set to 2, the Fourier-series imaging condition is considered to be an elastic imaging condition for generating a reverse time migration angle gather.

14. The computing system of claim 11, wherein in response to reciprocity being applied to the Fourier-series imaging condition and a series order of the Fourier-series terms being set to be greater than 2, the Fourier-series imaging condition generates a reverse time migration angle gather.

15. The computing system of claim 11, wherein the operations further comprise incorporating a higher-order virtual source term in the Born modeling with a series order of greater than 2 in an elastic full waveform inversion to iteratively improve an angle resolution of the angle gather.

16. A non-transitory computer-readable medium storing instructions that, when executed by one or more processors of a computing system, cause the computing system to perform operations, the operations comprising:
receiving input data, wherein the input data comprises seismic data, and wherein the seismic data comprises seismic waves travelling through the subsurface formation;
generating a simulated source-side wavefield, a simulated receiver-side wavefield, and a P-wave velocity model based upon the input data, wherein the simulated source-side wavefield is a forward simulation of the seismic waves, wherein the simulated receiver-side wavefield is a backward simulation of the seismic waves, and wherein the P-wave velocity model is generated using seismic tomography and full waveform inversion (FWI);
producing an angle gather based upon the simulated source-side wavefield and the simulated receiver-side wavefield, wherein the angle gather comprises a plurality of subsurface images having different reflection angles, and wherein the angle gather is produced by:
(1) constructing Fourier-series terms based upon the simulated source-side wavefield, the simulated receiver-side wavefield, and the P-wave velocity model, wherein the Fourier-series terms are constructed in a Fourier-series imaging condition by applying different orders of time integrations and spatial gradients to the simulated source-side wavefield and the simulated receiver-side wavefield before they are combined in the Fourier-series imaging condition, wherein the Fourier-series imaging condition is used to construct the subsurface images, and wherein the Fourier-series imaging condition is determined based upon the simulated source-side wavefield and the simulated receiver-side wavefield;
(2) determining Fourier-series coefficients based upon a scattering pattern, wherein the scattering pattern is determined based upon weight stacking of the subsurface images with different reflection angles; and
(3) weight stacking the Fourier-series terms using the Fourier-series coefficients to produce the angle gather;
wherein rotation and/or reciprocity are applied to the Fourier-series imaging condition, wherein:
in response to rotation being applied to the Fourier-series imaging condition, the rotation effectively transforms one of the subsurface images having a zero reflection angle into the subsurface images with the different reflection angles by rotating the spatial gradients in the Fourier-series imaging condition;
in response to reciprocity being applied to the Fourier-series imaging condition and a series order of the Fourier-series terms being set to 2, the Fourier-series imaging condition is considered to be an elastic imaging condition for generating a reverse time migration angle gather; and/or
in response to reciprocity being applied to the Fourier-series imaging condition and the series order of the Fourier-series terms being set to be greater than 2, the Fourier-series imaging condition generates the reverse time migration angle gather with an angle resolution that is greater than an angle resolution achieved by the elastic imaging condition;
utilizing the angle gather in a virtual source term in Born modeling to improve an image quality of the angle gather, wherein the angle gather is utilized according to an adjoint of the Fourier-series imaging condition for a least-square reverse time migration, which iteratively improves the image quality of the angle gather, wherein the virtual source term utilizes the angle gather as a source in the Born modeling, and wherein the Born modeling linearizes a seismic wave equation that uses the virtual source term to re-radiate the simulated source-side wavefield;
incorporating a higher-order virtual source term in the Born modeling with the series order of greater than 2 in an elastic full waveform inversion to iteratively improve an angle resolution of the angle gather; and
displaying the angle gather with the improved image quality and the improved angle resolution.

17. The non-transitory computer-readable medium of claim 16, wherein the operations further comprise applying the scattering pattern to the Fourier-series terms with the series order of 2 to construct a first elastic parameterization in the elastic full waveform inversion.

18. The non-transitory computer-readable medium of claim 17, wherein the operations further comprise constructing a second elastic parameterization having a radiation pattern that is more balanced and exhibits less overlap than the first elastic parameterization.

19. The non-transitory computer-readable medium of claim 17, wherein the operations further comprise applying the scattering pattern to the first elastic parameterization as a preconditioning on gradients of the elastic full waveform inversion.

20. The non-transitory computer-readable medium of claim 16, wherein the operations further comprise performing an action in response to the angle gather, wherein the action comprises generating and/or transmitting a signal that instructs or causes a physical action to occur, and wherein the physical action comprises selecting where to drill a wellbore, drilling the wellbore, varying a weight and/or torque on a drill bit that is drilling the wellbore, determining a location and/or amount of hydrocarbons in the subsurface formation and then varying a drilling trajectory of the wellbore toward the hydrocarbons, varying a concentration and/or flow rate of a fluid pumped into the wellbore, or a combination thereof.
